(19) United States
(12) Patent Application Publication
(10) Pub. No.: US 2026/0221055 A1
(43) Pub. Date: Jul. 30, 2026

(54) System for Showcasing Collectibles

(71) Applicant: Collector Display Unlimited LLC, Nashville, TN (US)

(72) Inventor: Lawrence Morera, Nashville, TN (US)

(21) Appl. No.: 19/036,319

(22) Filed: Jan. 24, 2025

(51) Int. Cl. G09F 1/12

(52) U.S. Cl. CPC G09F 1/12

(57) ABSTRACT

The present disclosure pertains to a system designed for showcasing collectibles. The system comprises of a casing base, a gasket, a transparent cover, and at least one fastening mechanism. The gasket is engineered to fit securely within the casing base and hold at least one collectible. After the gasket is properly installed, the transparent cover is attached to the casing base, enclosing the collectible. The fastening mechanism includes at least eight fasteners that pass through the apertures in the cover, align with the corresponding apertures in the gasket, and securely fasten into the receptacles of the casing base, effectively sealing the collectible within the system and ensuring its protection and display.

### FIELD OF THE INVENTION

The present invention relates generally to the showcasing collectibles.

### BACKGROUND

While many photo frames and similar devices are designed to protectpaper-based materials, they often fail to accommodate hard collectibles such as coins, medals, awards, and other similar items. This limitation renders these devices impractical for individuals looking to safeguard and conveniently transport non-paper collectibles.

### SUMMARY OF THE INVENTION

A showcasing collectibles system is provided, comprising a casing base with a front side and a back side, where the front side features a central opening surrounded by at least eight receptacles and eight rectangular hollow sections along its edges, while the back side is fully enclosed and incorporates at least eight rectangular brick-like designs along its edges. The system includes a gasket with a central opening and at least eight apertures positioned along the edges surrounding the opening, with supporting walls on the back side of the gasket designed to securely fit into the central opening on the front side of the casing base, which is configured to accommodate one collectible. A transparent cover, featuring at least eight apertures and eight rectangular hollow sections along its edges, is designed to attach securely to the casing base after the gasket is properly installed. The fastening mechanism comprises at least eight fasteners that pass through the apertures in the transparent cover, align with the corresponding apertures in the gasket, and securely fix into the receptacles of the casing base. The system further comprises.

A method for providing A showcasing collectibles system is provided, comprising a casing base with a front side and a back side, where the front side features a central opening surrounded by at least eight receptacles and eight rectangular hollow sections along its edges, while the back side is fully enclosed and incorporates at least eight rectangular brick-like designs along its edges. The system includes a gasket with a central opening and at least eight apertures positioned along the edges surrounding the opening, with supporting walls on the back side of the gasket designed to securely fit into the central opening on the front side of the casing base, which is configured to accommodate one collectible. A transparent cover, featuring at least eight apertures and eight rectangular hollow sections along its edges, is designed to attach securely to the casing base after the gasket is properly installed. The fastening mechanism comprises at least eight fasteners that pass through the apertures in the transparent cover, align with the corresponding apertures in the gasket, and securely fix into the receptacles of the casing base to form a showcasing system.

### BRIEF DESCRIPTION OF THE DRAWINGS

FIG. 1 illustrates a front view of an embodiment of a showcasing collectibles system;

FIG. 1A illustrates a front view of an embodiment of a cover;

FIG. 2 illustrates a front view of an embodiment of a casing base;

FIG. 3 illustrates a rear perspective view of an embodiment of FIG. 1 and FIG. 2;

FIG. 3A illustrates a top view of an embodiment of FIG. 1 and FIG. 2;

FIG. 3B illustrates a left view of an embodiment of FIG. 1 and FIG. 2;

FIG. 4 illustrates a front view of an embodiment of a gasket;

FIG. 5 illustrates an exploded view of an embodiment of FIG. 1.

### DETAILED DESCRIPTION

The features, structures, and characteristics described herein may be combined in various ways across one or more embodiments of the invention. In the following description, numerous specific details are provided to ensure a comprehensive understanding of these embodiments. However, those skilled in the relevant art will appreciate that the invention can be implemented without some of these specific details or by using alternative methods, components, and approaches. Additionally, well-known structures, materials, and operations are not detailed extensively to prevent obscuring key aspects of the invention.

The present disclosure pertains to a system specifically designed for showcasing collectibles, comprising a casing base, a gasket, a cover, and a fastening mechanism. This system is detailed across several embodiments, where the collectibles are securely mounted by joining the cover, gasket, and casing base using the fastening mechanism. The design incorporates fasteners and alignment features to ensure the precise and secure assembly of these components, offering reliable protection for at least one collectible housed within the central opening of the casing display.

The term “collectible” means coins, archive, keepsake, remembrance, souvenir, token, trophy or medal, image or photo, but not limited to this.

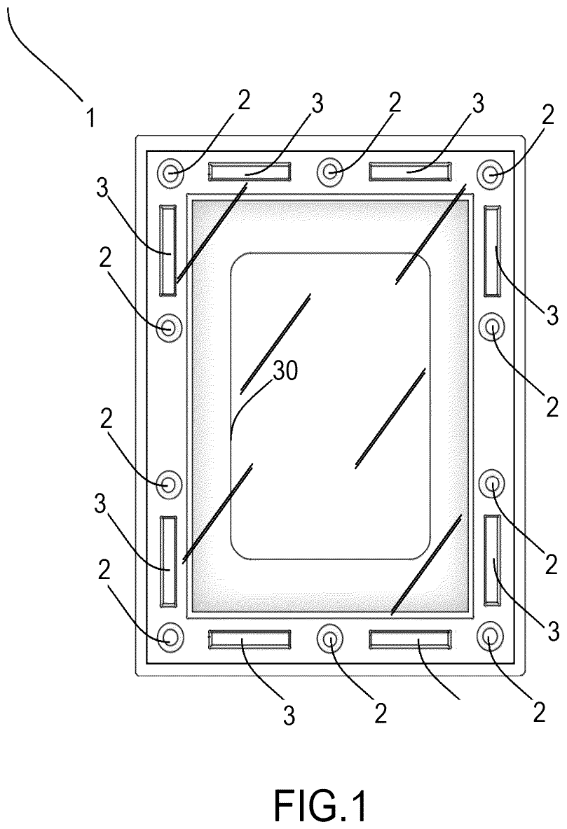

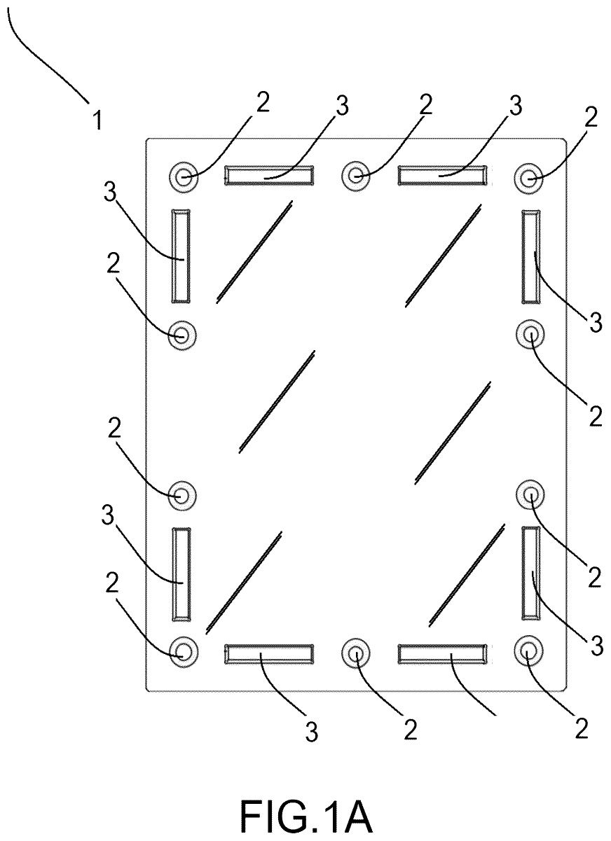

FIG. 1 illustrates a front view of an embodiment of a showcasing collectibles system (1) designed to display or showcase collectibles or other items. The system (1) consists of a cover (2), a casing base (11), a gasket (21), and a fastening mechanism, with the figure depicting the assembly of these component parts. A central opening (30) is shown intended to accommodate at least one collectible. The central opening (30) is depicted as an empty area designed to accommodate at least one collectible. While it is shown as rectangular, however, they may be of any other shape.

FIG. 1A illustrates a front view of an embodiment of a cover (2). The cover (2) or lid is a transparent plate-like one-piece and having at least eight apertures (3) and at least eight hollow sections (4) along the edges. The hollow section or sections (13) along the edges of the cover (2) is illustrated as being rectangular or brick-like shaped; however, they may be of any other shape. In one embodiment of the height of the cover (2) may range from approximately 2.5 mm to approximately 4.5 mm. The length of cover (2) may range from approximately 90 mm (3.54 inches) to approximately 127 mm (5 inches). In one embodiment, the width of cover (2) may range from approximately 88.9 mm (3.5) to approximately 108 mm (4.25 inches).

In one embodiment, the cover (2) has at least eight apertures (3) along the edges. The size of each aperture (3) may range from approximately Ø3×6 to approximately Ø3.8×10. In another embodiment, the aperture (3) can be of any shape including circular, but not limited to the shape mentioned. The distance between one to another aperture along the edge of the cover (2) may range from approximately 31 mm to approximately 45 mm but not limited to this distance.

In one embodiment, the cover (2) having rectangular hollow sections along the edges. The rectangular hollow sections (4) can be of any shape including rectangle, square, brick-like, but not limited to this. The length of the rectangular hollow sections (4) is around 16 mm to 22 mm depending upon the size of the casing system. In another embodiment, the width of rectangular hollow sections (4) is around 2 mm to 4.2 mm depending upon the size of the casing system.

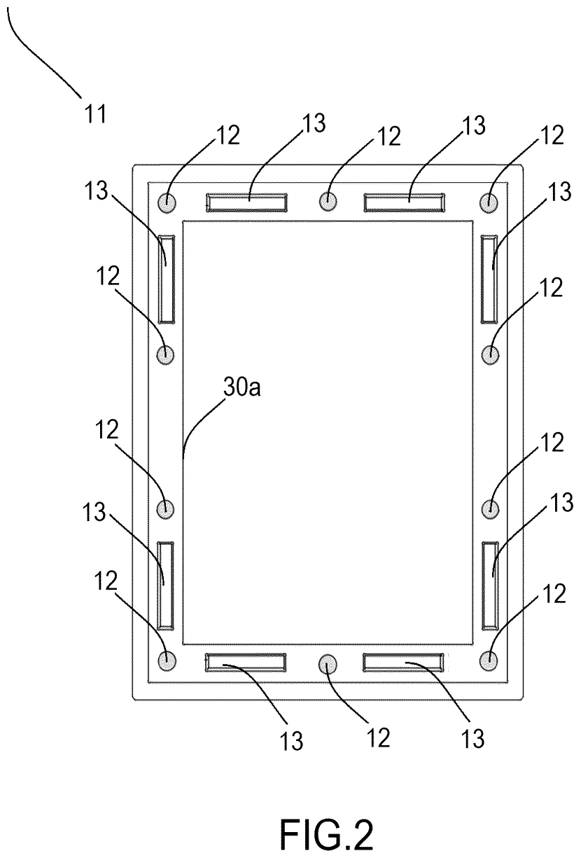

FIG. 2 illustrates a front view of an embodiment of a casing base (11). The casing base (11) described in this disclosure consists of a front side. The front side includes a central opening (30a), designed to hold at least one collectible with or without help of a gasket (21), along with at least eight receptacles (12). Additionally, it features at least eight hollow sections (13) positioned along its edges. The hollow section or sections (13) along the edges of the casing base (11) is illustrated as being rectangular or brick-like shaped; however, they may be of any other shape.

In one embodiment, the casing base (11) is a one-piece plastic (not limited to plastic). In another embodiment of the height of the casing base (11) may range from approximately 9 mm to approximately 15 mm. In another embodiment, the length of casing base (11) may range from approximately 90 mm (3.54 inches) to approximately 127 mm (5 inches). In another embodiment, the width of casing base (11) may range from approximately 88.9 mm (3.5) to approximately 108 mm (4.25 inches).

In one embodiment, the casing base (11) is adapted to receive at least one collectible and the length of the central opening (30a) where at least one collectible mounted may range from approximately 80 mm to approximately 95 mm. In another embodiment, the width of that area where at least one collectible mounted may range from approximately 45 mm to approximately 70 mm.

In one embodiment, the casing base (11) has at least eight receptacles on its side walls but not limited to this. The size of each receptacle may range from approximately Ø3.5×5 to approximately Ø4.5×6. In another embodiment, a receptacle can be of any shape including circular, cylindrical, oval, but not limited to the shapes mentioned. The distance between receptacles on the side walls of the casing base (11) may range from approximately 31 mm to approximately 45 mm but not limited to this distance.

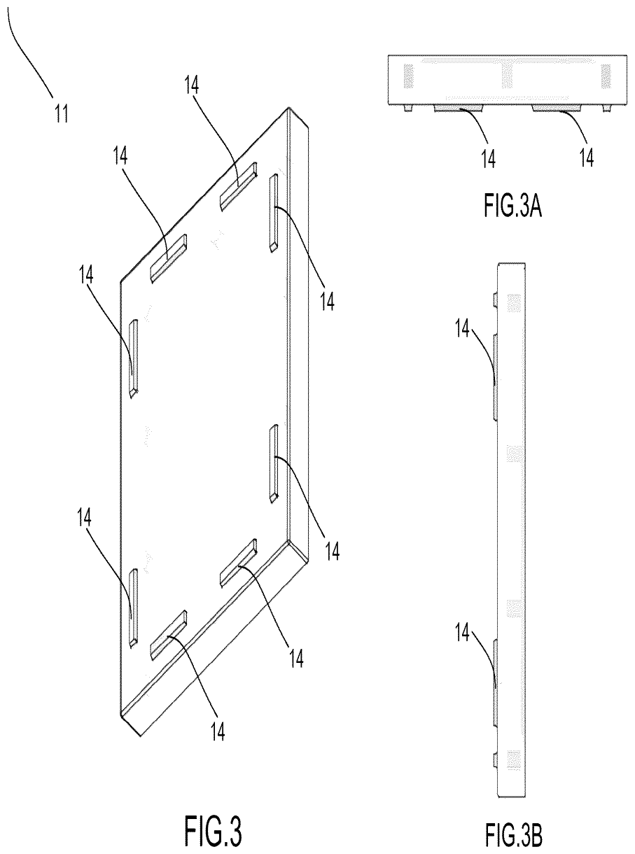

In one embodiment, the casing base (11) is designed with hollow sections (13) along the edges of its front side and brick-like shaped sections (14) along the edges, which are fully enclosed on the back side (see FIG. 3). The sections (including hollow sections (13) and brick-like shaped (14)) can be of any shape including rectangle, square, brick-like, but not limited to this.

In one embodiment, the length of the rectangular hollow sections (13) is around 16 mm to 22 mm depending upon the size of the casing system. In another embodiment, the width of rectangular hollow sections (13) is around 2 mm to 4.2 mm depending upon the size of the casing system.

FIG. 3 illustrates a rear perspective view of an embodiment of a casing and displaying collectible system (1) while FIG. 3A illustrates a top view and FIG. 3B illustrates a left view of embodiments of a showcasing collectible system (1). The system features the casing base (11) described in this disclosure consist of a back side. The back side of the casing base (11) is fully enclosed, incorporating brick-like (14) rectangular shapes along its edges. The designs (14) or brick-like shaped designs along the edges on the backside of the system (1) is illustrated as being rectangular; however, they may be of any other shape. In one embodiment, the length of the brick-like rectangular shapes (14) is around 16 mm to 22 mm depending upon the size of the casing system. In another embodiment, the width of brick-like rectangular shapes (14) is around 2 mm to 4.2 mm depending upon the size of the casing system.

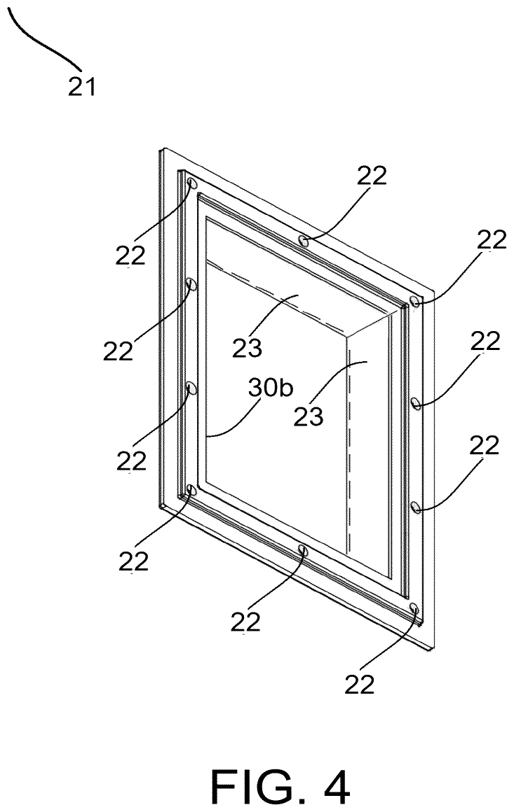

FIG. 4 illustrate perspective view of a window-like gasket (21) that is opened from its central opening (30b) and has a front side and a back. The gasket (21) has at least eight apertures (22) along the edges and the back side has at least four supporting walls (23) attached for better fixation of the gasket (21) in the casing base (11).

In one embodiment, the height of the gasket (21) may range from approximately 8 mm to approximately 12 mm. In another embodiment, the length of gasket (21) may range from approximately 90 mm (3.54 inches) to approximately 127 mm (5 inches). In another embodiment, the width of the gasket (21) may range from approximately 88.9 mm (3.5) to approximately 108 mm (4.25 inches).

In one embodiment, the length of the central opening (30b) of the window-like gasket (21) may range from approximately 80 mm to approximately 95 mm. In another embodiment, the width of that area where at least one collectible mounted may range from approximately 45 mm to approximately 70 mm.

In one embodiment, the gasket (21) has at least eight apertures (22) along the edges. The size of each aperture (22) may range from approximately Ø3×6 to approximately Ø3.8×10. In another embodiment, the aperture (22) can be of any shape including circular, cylindrical, oval, but not limited to the shapes mentioned. The distance between one to another aperture (22) along the edges of gasket (21) may range from approximately 31 mm to approximately 45 mm but not limited to this distance

In one embodiment, the back side of gasket (21) has at least four supporting walls (23) along the edges (see FIG. 8). The supporting walls (23) are integrated into the design to securely hold the gasket (21) in place within the casing base (11), ensuring better fixation and stability.

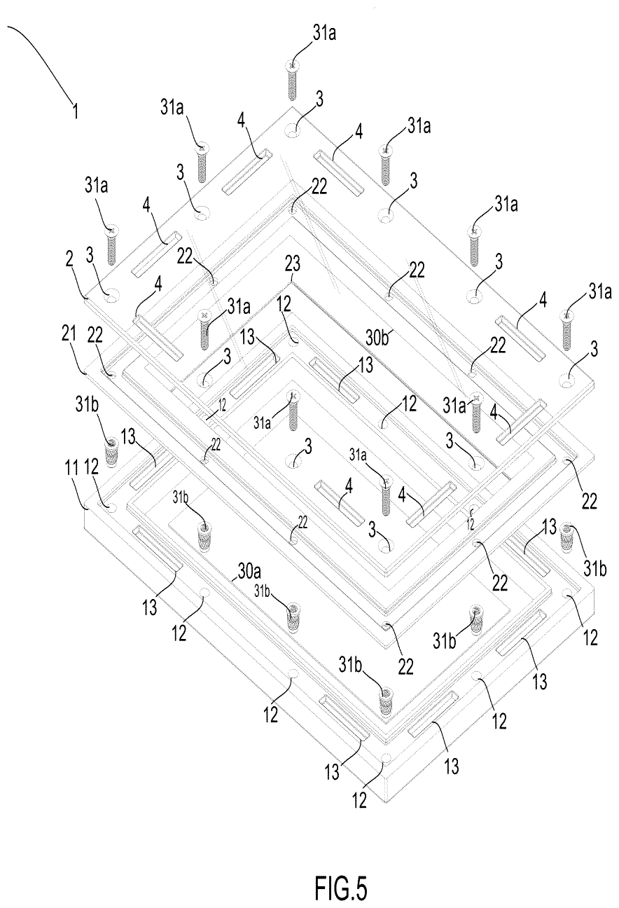

FIG. 5 illustrates an exploded view of an embodiment of a showcasing collectibles system (1). A system (1) comprises a cover (2), a casing base (11), a gasket (21), and a fastening mechanism. The casing base (11) features a front side and a back side, with the front side including a central opening (30a) surrounded by at least eight receptacles (12) and eight rectangular hollow sections (13) along its edges. The back side is fully enclosed and incorporates at least eight rectangular brick-like designs (14) along its edges. The gasket (21) includes a central opening (30b), at least eight apertures (22) positioned around the edges of the opening, and supporting walls (23) on its back side, designed to securely fit within the central opening (30a) of the casing base (11). The central opening (30) is specifically designed to accommodate at least one collectible. The transparent cover (2) has at least eight apertures (3) and eight rectangular hollow sections (4) along its edges, and it is designed to attach securely to the front side of the casing base (11) once the gasket (21) is properly installed. The fastening mechanism includes bolts or screws (31a)—such as hex head, flat head, or pan head screws—and nuts (31b), which are securely positioned within the receptacles (12) of the casing base (11). At least eight screws (31a) are used to secure the system (1), passing through the apertures (4) in the transparent cover (2), aligning with the corresponding apertures (22) in the gasket (21), and fastening securely into the nuts (31b) within the receptacles (12). The number of apertures on the cover and gasket and the number of receptacles on the casing base exactly match the number of fasteners, ensuring a precise and secure assembly.

To use the system, the consumer attaches the supporting walls (23) of the gasket (21), located on its back side, to the central opening (30a) on the front side of the casing base (11). A collectible—such as a coin, photo, archive, keepsake, souvenir, token, trophy, card, award certificate, or other item of interest—can then be placed in the central opening (30). The transparent cover (2) is then secured with fasteners, ensuring the collectible remains protected. This showcasing collectibles system (1), as described in the present invention, adds a decorative touch to any room. Its versatile design allows for effortless adaptation to evolving tastes, easy relocation between spaces, or swapping out the displayed collectible with a new one. Furthermore, the system (1) is not restricted to residential use and is suitable for various professional or public environments, including offices, restaurants, classrooms, libraries, art galleries, and more.

The description of the present invention has been presented for purposes of illustration and description, but is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. A system for showcasing collectibles comprising:
a casing base having a front side and a back side wherein the front side comprises a central opening surrounded by at least eight receptacles and at least eight rectangular hollow sections along the edges; the back side is fully enclosed and incorporates at least eight rectangular shaped designs along its edges;
providing a gasket having a central opening and at least eight apertures positioned along the edges surrounding the opening; and supporting walls on the backside of the gasket is designed to securely fix to the central opening on the front-side of the casing base, while the central opening is configured to accommodate one collectible;
a transparent cover having at least eight apertures and at least eight rectangular hollow sections along its edges and the cover is designed to attach securely to the casing base after the gasket is properly fixed in place;
at least a fastening mechanism for fixing the system comprising at least eight fasteners passes through the apertures in the transparent cover, align with the corresponding apertures in the gasket, and securely fix into the receptacles of the casing base;
wherein the number of apertures on the cover and the gasket and the number of receptacles on the casing base exactly match the number of fasteners.

2. The system as claimed in claim 1, wherein the number of the at least eight apertures on the transparent cover and the gasket and at least eight receptacles on the casing base depend on the size and shape of the casing base.

3. The system as claimed in claim 1, wherein the edges of the casing base and the gasket comprise a line, space or likewise designs that facilitate positioning of the casing base, gasket and transparent cover together in a pre-determined layout.

4. The system as claimed in claim 1, wherein the shape of a casing display can be of rectangle, square, rounded square and not limited to this.

5. The system as claimed in claim 1, wherein the height of a showcasing display may range from 9 mm to approximately 15 mm, the length may range from approximately 90 mm (3.54 inches) to approximately 127 mm (5 inches), and the width may range from approximately 88.9 mm (3.5) to approximately 108 mm (4.25 inches).

6. The system as claimed in claim 1, wherein the length of the central opening of a showcasing display where at least one collectible mounted may range from approximately 80 mm to approximately 95 mm, and the width of central opening may range from approximately 45 mm to approximately 70 mm.

7. A method for providing a system for showcasing collectibles comprising:
providing a casing base with a front side and a back side, where the front side having a central opening surrounded by at least eight receptacles and at least eight rectangular hollow sections arranged along its edges; enclosing back side of the casing base and incorporating at least eight rectangular shaped sections along its edges;
providing a gasket with a central opening and at least eight apertures positioned along the edges surrounding the opening, the gasket also includes supporting walls on its back side and is designed to securely fit within the central opening on the front side of the casing base, said central opening is specifically configured to accommodate one or more collectibles;
providing a transparent cover with at least eight apertures and at least eight rectangular hollow sections along its edges and the cover is designed to attach securely to the casing base after the gasket is properly fixed in place;
at least a fastening mechanism for fixing the system comprising at least eight fasteners passes through the apertures in the transparent cover, align with the corresponding apertures in the gasket, and securely fix into the receptacles of the casing base to form a casing system;
wherein the number of apertures on cover and gasket and the number of receptacles on the casing base exactly match the number of fasteners.

8. The system as claimed in claim 7, wherein the number of the at least eight apertures on the transparent cover and the gasket and at least eight receptacles on the casing base depend on the size and shape of the casing base.

9. The system as claimed in claim 7, wherein the edges of the casing base and the gasket comprise a line, space or likewise designs that facilitate positioning of the casing base, gasket and transparent cover together in a pre-determined layout.

10. The system as claimed in claim 7, wherein the shape of a casing display can be of rectangle, square, rounded square and not limited to this.

11. The system as claimed in claim 7, wherein the height of a showcasing display may range from 9 mm to approximately 15 mm, the length may range from approximately 90 mm (3.54 inches) to approximately 127 mm (5 inches), and the width may range from approximately 88.9 mm (3.5) to approximately 108 mm (4.25 inches).

12. The system as claimed in claim 7, wherein the length of the central opening of a showcasing display where at least one collectible mounted may range from approximately 80 mm to approximately 95 mm, and the width of central opening may range from approximately 45 mm to approximately 70 mm.
